(19) United States
(12) Patent Application Publication
(10) Pub. No.: US 2006/0282369 A1
(43) Pub. Date: Dec. 14, 2006

(54) One touch hybrid trading model and interface

(76) Inventor: William P. White, Summit, NJ (US)

Correspondence Address: DARBY & DARBY P.C., P. O. BOX 5257, NEW YORK, NY, 10150-5257, US

(21) Appl. No.: 11/452,797

(22) Filed: Jun. 13, 2006

(51) Int. Cl. G06Q 40/00

(52) U.S. Cl. 705/37

(57) ABSTRACT

A computer based trading system for trading one or more financial instruments on at least one electronic exchange. The system includes a server connected to a client terminal over a communication network. The client terminal includes a GUI that displays an order book a histogram representing the market activity occurring on at least one of the plurality of electronic exchanges of a specified financial instrument. A user of the system creates and places orders by using a user pointer device coupled with the GUI so as to simultaneously a price and quantity as coordinate pair data corresponding to an arbitrary location of interaction with the GUI based on a user action. The coordinate pair data is available at continuous locations on the GUI.

### FIELD OF THE INVENTION

The present invention relates to a financial instrument electronic trading platform and, more particularly, is directed to an electronic trading platform capable of hybrid operations that provides a user with a graphical representation of market activity and interactively place orders for financial instruments.

### BACKGROUND OF THE INVENTION

Electronic trading of financial instruments over electronic communication networks (“ECNs”) has intensified the speed and volume of trades on today's financial markets. It is crucial to provide a trader with detailed information in an organized and easily understandable format that allows the trader to recognize, understand, and respond to rapidly changing market conditions.

Current systems include the display of trend data, including market volume and price, over varying periods. Additionally, many systems provide textual charts identifying price points and the number of shares being offered or sold at the specified price point. These presentations require a trader to expend a significant time analyzing as the trader pieces together the existing market landscape and analyzes market pressures and resistances.

Responding to changing market conditions typically requires the input of various pieces of data that result in a trade order being placed on one or more exchanges. Typically, a user is required to input parameters specifying the financial instrument, the price, the quantity, and the type of order (i.e., buy, sell, option). Furthermore, these parameters are typically input by keypad entry or a combination of keypad entry and user pointer device using a window or form entry screen that is disconnected and separate from the market data display. Therefore, the trader must shift focus from the market data to order entry, thus requiring a mental context shift, lost time, and possible placing trade orders based on out of date market information.

Thus, the analysis of market data presentation and the data entry required by a trader in reacting to market conditions consumes significant and precious time. In today's frenetic markets, the amount of time that passes between beginning the entry of an order and transmitting the order to the exchange may result in a missed window of opportunity. This is especially true for “day traders” or professional traders that frequently trade financial instruments within a range of pennies from the last market trade. Additionally, existing systems require a trader to lose focus of, or split focus between, market data and order entry.

### SUMMARY OF THE INVENTION

One embodiment of the present invention provides a computer based trading system for trading one or more financial instruments on at least one electronic exchange. The system includes a server connected to a client terminal over a communication network. The client terminal includes a display having a GUI presentation on the display, and a graphical application interface module in data communication with the GUI. An order book module displays on the GUI a histogram of market activity for a financial instrument occurring on at least one of the plurality of electronic exchanges, and the order book module is in communication with the graphical application interface module. The system further includes an order entry module in communication with the graphical application interface module, the order entry module operable to analyze user actions and selectively create trade orders. A user pointer device interactively coupled with the GUI so as to simultaneously provide a first value representing a price and a second value representing a quantity to the order entry module as coordinate pair data corresponding to an arbitrary location of interaction with the GUI based on a user action. The coordinate pair data is available at continuous locations on the GUI. The system further includes a server communication module in communication with the order entry module, configured to receive any trade order that has been created, and operable to transmit such trade orders to the server, wherein the server contacts at least one of the electronic exchanges so as to place the trade order.

In a more particular feature of the present invention, the system further includes at least one computer processor operable to execute instructions associated with the order entry module, so as to transform the coordinate pair information, representing price and quantity, into a trade order concerning the displayed financial instrument.

### BRIEF DESCRIPTION OF THE DRAWINGS

FIG. 1 illustrates an embodiment of a communication network that connects clients to ECNs;

FIG. 2 illustrates a block diagram of an embodiment for a trading system in accordance with the present invention;

FIG. 3 depicts a flow diagram illustrating steps of a process in accordance with an embodiment of the present invention;

FIG. 4 depicts an exemplary GUI in accordance with an embodiment of the present invention;

FIG. 5 depicts a further exemplary GUI displaying trade-algorithm selections and algorithm-parameter inputs; and

FIG. 6 depicts a third exemplary GUI displaying both equity-market data and options-market data.

### DETAILED DESCRIPTION OF CERTAIN PREFERRED EMBODIMENTS

By way of overview and introduction, the present invention provides a computer-based trading system for trading one or more financial instruments on at least one electronic communication network (“ECN”), which is an electronic exchange that connects brokerages and individual traders so that they can trade directly. The computer-based trading system provides a histogram of market activity for selected financial instruments presented on a display of a client terminal. The histogram is interactive so as to enable a user to place orders concerning the displayed financial instrument by using a user-pointer device that is coupled to a graphical user interface (GUI). The user can manipulate the user-pointer device so as to simultaneously and arbitrarily select a price and quantity of a desired user trade order on the histogram representation of market activity. The client terminal transmits the order to a server which forwards the order to an ECN.

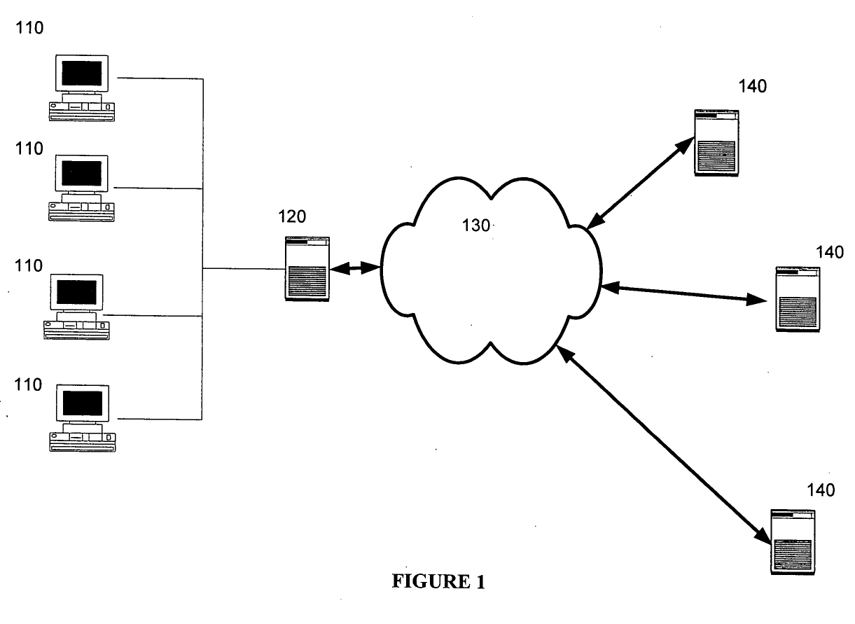

FIG. 1 illustrates an embodiment of the invention including a communication network in which several client terminals are shown connected to a server which communicates with one or more ECNs over a network. A user can view the market activity of one or more financial instruments on the client terminal and place trades on one or more of the ECNs by interacting with the client terminal.

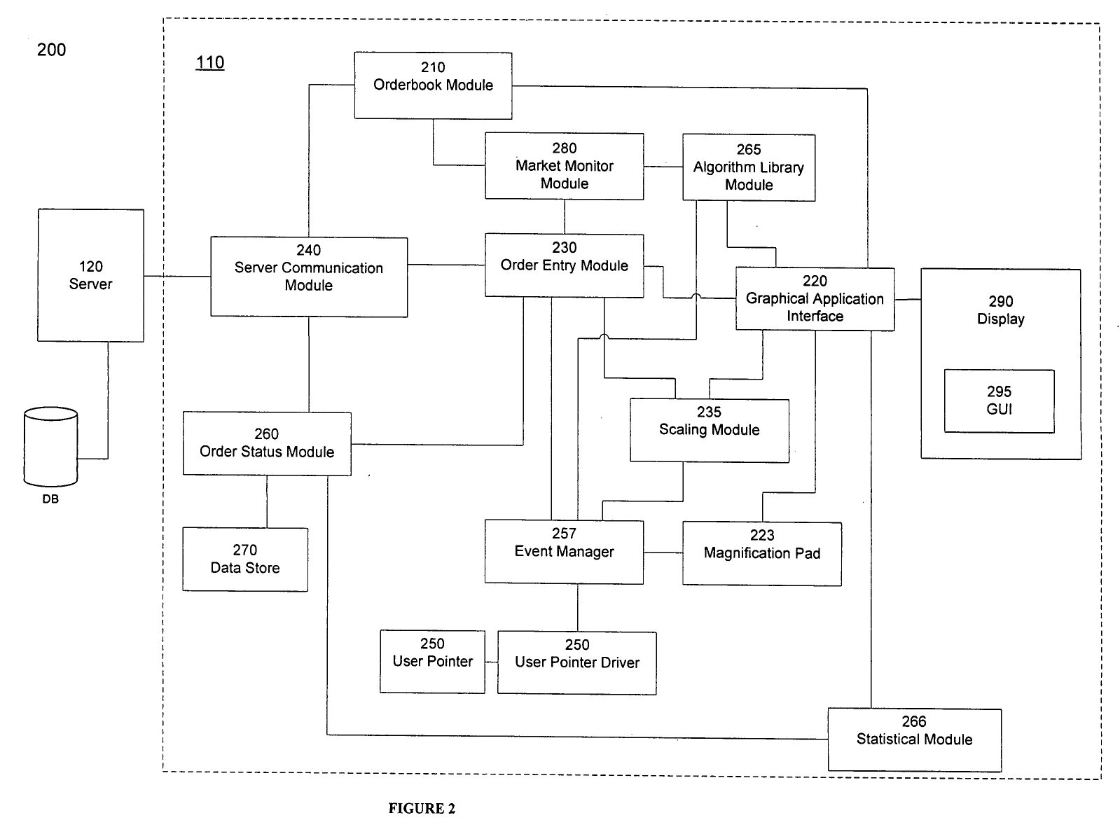

FIG. 2 depicts a block diagram of a trading system 200 in which details of the client terminal in accordance with an embodiment of the invention are illustrated. Through the coordinated action of a number of software modules, financial information is processed and displayed through the GUI 400. The software modules include: Orderbook Module 210; Graphical Application Interface 220; Magnification Pad 223; Order Entry Module 230; Scaling Module 235; Server Communication Module 240; User Pointer Driver 255; Event Manager 257; Order Status Module 260; Algorithm Library Module 265; Statistical Module 266; Data Store 270; and Market Monitor Module 280. The function of these modules is described in detail below, but more generally operate as follows:
Server Communication Module 240: facilitates communication with one or more ECNs by translating messages to and from a standard protocol (e.g., FIX).
Orderbook Module 210: tracks and processes market data received from an ECN to define the histogram 405 representing market data.
Order Entry Module 230: translates user interaction with the GUI into trade orders which are communicated to other software modules to perform necessary updates.
User Pointer Driver 255: controls the user pointer device 250 and generates pointer events.
Event Manager 257: packages and distributes pointer device events to the appropriate software module.
Graphical Application Interface 220: controls the display and presentation of the GUI 400.
Order Status Module 260: maintains and updates user trade orders.
Market Monitor Module 280: tracks market data and executes predefined actions in response to changes in market data.
Algorithm Library Module 265: stores and defines trading algorithms and user inputs to the trading algorithms.
Statistical Module 266: tracks and computes statistics based on a user's fulfilled, pending, and cancelled orders.
Magnification Pad 223: magnifies a portion of the histogram to facilitate the user in accurately entering a trade order at the desired price and quantity.
Scaling Module 235: interacts with order entry module to enable a user to increase or decrease all outstanding user-buy-orders or user-sell-orders orders.

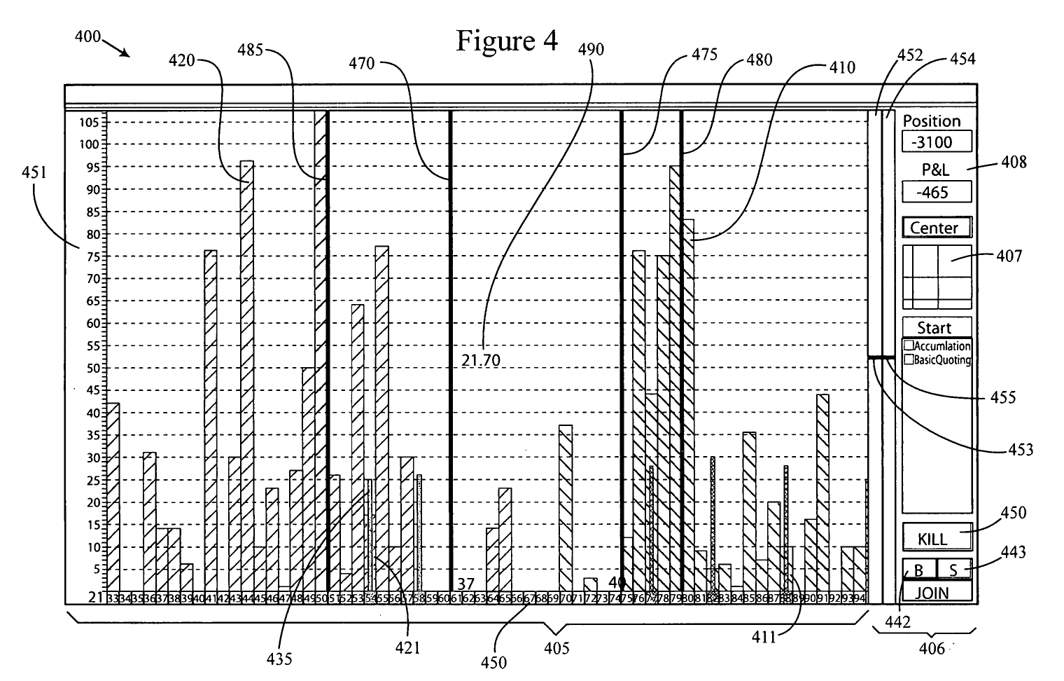

With reference now to FIGS. 2 and 4, the software modules listed above will be described in further detail generally in the order of the communication path and operation of the trading system.

Server communication module 240 receives streaming market data from the server 120 and forwards the data to an order book module 210. The order book module 210 is also in communication with a graphical application interface 220, and the market monitor module 280. The graphical application interface 220 controls the display content of a graphical user interface (GUI) 295 on a terminal display 290. The order book module 210 transforms the market data received from the server 120 or directly from ECNs 140 into a histogram 405 of price and quantity for display on the GUI 400. Data transmission between the client terminal 110 and the sever 120 and/or the ECN 140 can be accomplished through a standard message format known in the art, or through a proprietary messaging format if desired. One such standard messaging format is the Financial Information eXchange (“FIX”) protocol. The FIX Protocol is a messaging standard developed for the real-time electronic exchange of securities transactions. More specifically, FIX is a series of messaging specifications developed to facilitate the electronic communication of trade related messages. The FIX protocol includes specifications for information security, order flow handling, market data transmission, and user defined fields.

The server communication module 240 can interface with one of the many third party FIX implementations that provide an application programming interface (“API”) to send and receive FIX messages. A FIX implementation typically provide methods or subroutines, which can be invoked with appropriate parameter information defining the desired trade-order or trade-related message, and can pack and encapsulate the information into one or more network messages (e.g., TCP packets). The FIX implementation also receives FIX network messages, unpacks and parses the data into predetermined parameters, and can invoke an appropriate trading system module callback method or generate an event which will be handled by the appropriate trading system module. The server communication module 240 thus analyzes the information parsed from the FIX message and determine which module should receive the data that was encapsulated in a given FIX message.

The bar graph 405 illustrated in FIG. 4 is referred to herein as a “histogram” and represents a distribution of market orders over a range of prescribed price increments. Preferably and as illustrated, the price increments are regularly distributed along the x-axis (the price axis). The order quantity at each respective price is also preferably distributed in a regular manner along the y-axis (the quantity axis). For example, if a specific stock is being displayed in the histogram 405, each unit along the x-axis can represent $0.01, the tradable increment of an individual stock. Alternatively, if the histogram 405 is displaying an ETF that is traded in $0.25 increments, each unit along the x-axis preferably represents $0.25. Preferably, price and quantity are linearly distributed along the axis, however, other scales (e.g., logarithmic) can be used. The height of each bar is proportional to the quantity of market orders at the particular tradable increment designated by the position of the bar on the x-axis. Between each plottable point there can be gaps such that data at each interval is spaced somewhat from an adjacent interval on either or both axes.

The server communication module 240 transmits market data to the orderbook module 210. The orderbook module 210 further determines how each bar in the histogram 405 is displayed by transforming the data received from the ECN 140 into histogram data. Each bar of the histogram 405 preferably represents the total quantity of outstanding market orders for a financial instrument at a specific price on at least one exchange. Preferably, the histogram 405 includes market data gathered from multiple ECNs 140. The order book module 210 can scale the axis of the histogram 405 to display market activity in an intuitive manner. For example, the total quantity of outstanding orders on the y-axis 451 in FIG. 4, can be scaled such that for all the prices displayed along the x-axis 450, each histogram bar can be completely displayed within the histogram 405 display. In other words, the orderbook module 210 scales the histogram 405 such that no or few histogram bars are truncated on the display (e.g., by changing the intervals along the y-axis). Additionally, the orderbook module 210 can display a range of prices along the x-axis 450 in an intuitive manner. For example, the orderbook module 210 can re-center the histogram 405 such that the most recent trade (i.e., market price) of a financial instrument is in the center of the histogram 405. Alternatively, the x-axis 451 can be scaled such that a predetermined percentage of outstanding market orders are displayed in the histogram 405. Such changes to the quantity and price axes preferably are user-configurable settings through the GUI 400.

With further reference to FIG. 4, the histogram 405 displays the current market activity for a particular commodity (as illustrated, Hewlett Packard Co.). The market activity displayed by histogram 405 includes open buy orders 420 and sell orders 410 on one or more ECNs 140. The options market for a particular commodity can also be included in the totals displayed by the histogram 405, for example as an overlay. If desired, the options market can be displayed in a separate options histogram not unlike histogram 405. Each grid coordinate on the histogram 405 represents a specific price and quantity of the displayed financial instrument.

The buy and sell orders of a user at a given client machine are preferably differentiated from the open orders of third parties. Buy orders 435 and sell orders 430 placed by a user of the client terminal 110 can be differentiated from the other market activity within the GUI 400, for example, by using any combination of colors, shading, or selected width for the histogram bar of the buy and sell orders 435, 430. Buy orders can also be differentiated from sell orders in a similar manner. Likewise, options, stop orders, limit orders, and other types of trades can be differentiated in their representation on the histogram 405. This differentiation allows a user to quickly and easily understand the state of the market and the user's market position and pending orders for a particular financial instrument through a single visual representation, and through user-configurable settings the differentiations of any of the foregoing order types can be selected or disabled at a given client terminal 110.

As illustrated in FIG. 4, user orders 430 and 435 are distinguished from other market activity 410 and 420 in the GUI 400 by the order entry module 230. The user orders 430 and 435 are shown displayed in a narrower bar, and a different color than the other market activity. Further, in the illustrated embodiment of the GUI 400, user order show quantities starting at zero rather than accumulated on top of a bar with other orders for the same instrument at the same price. However, the order entry module 230 can display user orders appended to (accumulated with) the non-user market orders, such that the length of the histogram bars can represent the total market activity (i.e., user orders and non-user orders) on the ECNs 140 being monitored, however, the portion of the market activity associated with a user's orders can still be differentiated from the non-user orders by shading or coloring a portion the portion of the histogram bar corresponding to the user order differently than the portion of the histogram bar representing non-user orders. Alternatively, user orders 430 and 435 can be superimposed on the market activity. In this configuration, the non-user market activity bars do not represent the true or absolute market activity because they exclude user orders. For example, the buy orders represented by 421 do not include the quantity represented by the user's buy order 435.

The GUI 400 can further display additional market information. The GUI 400 displays the price of the last trade 490 within the GUI 400. A sweep zone comprising a range of prices on either side of the market price can be represented by a sweep upper bound 475 and a sweep lower bound 470. Additionally the background of the sweep zone between sweep bounds 470 and 475 can be shaded differently from the remainder of the histogram 405. The GUI can also display a market-liquidity-refreshment point by an upper momentum bound 480 and a lower momentum bound 485. These boundaries are computed in a conventional manner, yet provide useful information that is dynamically updated by the order book module 210 for presentation on the display 290 in coordination with the open order information in the GUI to guide the user in his or her instructions with the interface 295.

While viewing the information described above as it is presented and updated, a user can interact with the GUI 400 displayed on the display 290 using a user pointer device 250 which communicates with the interface by way of a user pointer driver 255. Trade orders can be placed through the client terminal 110 through a user action with the user pointer device 250 and the GUI 400. The user pointer device 250 can be a computer mouse, light pen, touch screen, computer tablet, keyboard entry (e.g., arrow keys), or other similar device.

By way of example, if the pointer device 250 is a computer mouse, the user can enter a trade order by simply clicking on the histogram bar 405 of a financial instrument displayed on the GUI 400 at the grid coordinate representing the price and quantity of the desired trade on one side or the other of the current market price. The price/quantity data is simultaneously determined by the user action. Also, whether the order is a buy or sell order can be determined based on the point of interaction with the interface relative to the current market price.

A user action simultaneously provides both a price and a quantity of a desired order to the order entry module 230. In one implementation, the specified user action is an event triggered by the user pointer device 250 (e.g. “mouse click”). The user action results in an event being generated by the user pointer driver 255 which is handled by an event manager 257. The order entry module 230 can register to receive user pointer events generated by user interaction with the histogram 405 displayed in the GUI. Thus, when the event manager 257 receives the user pointer device 250 event, it transmits the event to the order entry module 230. The user pointer event includes parameters identifying the grid coordinate on the histogram 405 at which the event occurred. The grid coordinates are transformed by the order entry module 230 from (x, y) coordinate pair information into the price and quantity represented by the user pointer location on the histogram 405 at the moment of the user pointer event.

The precise user action that triggers the trading system 200 to generate a trade order can take several forms. For example, in a tablet computer environment, the trading system 200 may generate a trade order when the user merely touches the display of the client terminal 110. Preferably, the trade order can be generated when the user lifts the pointer off the display, or releases the mouse button. By triggering the creation of trade orders using the release of a click-and-release, the user can place the pointer on the screen and then move the pointer to the desired arbitrary location. In this manner, if the user's initial contact with the screen is mistakenly placed, the user may adjust the position of the pointer device 250 and thus correct the parameters (i.e., the price and quantity) of the trade order that is about to be created by the system upon completion of the user action.

The order entry module 230 utilizes the price and quantity represented by the coordinate pair information associated with the completion of the user event within the histogram region 405 to generate a trade order. In an object-oriented environment, each trade order can be represented by a trade order object created by the order entry module 230 which encapsulates all the data necessary to define the trade order. A trade order typically includes information in addition to the price and quantity such as an identification of the particular instrument, whether the order is to buy or sell that instrument, an order number, and a date/timestamp. The trade order object can further provide methods to execute the trade order, cancel the trade order, fulfill the trade order, or modify the trade order.

The trade order object can be a persistent object stored within the data store 270 or a client database (not shown). When the client terminal 110 is disconnected from the ECN 140, the trade order objects may become stale (i.e., the state of the object on the client terminal 110 may not correctly reflect the state of the trade order on a particular ECN 140. When the client terminal 110 is disconnected from the ECN 140, the order status module 260 can delete all the objects stored in the data store 270 that represent user trade orders. When the client terminal 110 is reconnected to the ECN 140, the client terminal 110 can refresh its data store 270 of trade order objects representing pending and executed trade orders using messages from the order management system of the ECN 140. Alternatively, the client terminal 110 can synchronize the state of its trade order objects by querying the ECN 140 or through automated messages from the ECN 140.

The data encapsulated by the trade order object can be communicated to the server communication module 240 which formats the data as an ECN 140 message (e.g., a FIX message) and transmits the order to the ECN 140.

Optionally, the client terminal 110 can manage its internal data by storing FIX messages in the data store 270 and enabling various system modules to access and extract the necessary data from the FIX messages. However, because there is some processing overhead associated with the parsing of FIX messages, it may be desirable to transform any FIX messages into objects or other data structures. This transformation can take place immediately upon receipt by the server communication module 240 or at some point further into the communication path. Delaying the translation of FIX messages enables modules that primarily analyze and communicate data in FIX messages, such as the order entry module 210, to eliminate the overhead of transforming data to and from FIX messages and enables other modules to store data in proprietary data structures, such as the market monitor module 280, which can benefit from more efficient data structures to perform its analysis. Furthermore, in a distributed environment, data and messages can be passed using a CORBA interface, or other distributed messaging interface as is known in the art.

In another feature the present invention, the order entry module 230 autonomously determines whether the trade order resulting from the user action is a buy order or a sell order. The order book module 210 receives the market activity from the server communication module 240 for a particular instrument and, thus, is programmed to utilize the most recent trade price 490 (i.e., market price) of the instrument to determine whether the trade order is a buy order or a sell order. If the price of the trade order generated by the user action is less than the market price 490 of the instrument, the order book module 230 determines that the trade order is a buy order. If the price of the trade order is greater than the market price 490, the order entry module 230 determines that the trade order is a sell order. Consequently, the transaction details of price, quantity, instrument (or basket, derivative, etc., as is discussed below), buy or sell, are all establishable through a user event such as a single click of a pointing device 250.

Alternatively, the user can specify whether a trade order is a buy or sell by selecting the buy mode button 442 or the sell mode button 443 within the GUI 400. Optionally, the order entry module 230 can require the user to select the buy mode button 442 or the sell mode button 443 for all trades, or for trade orders within a specific dollar or percentage difference of the market price 490. This is useful for beginners to prevent unintended trades.

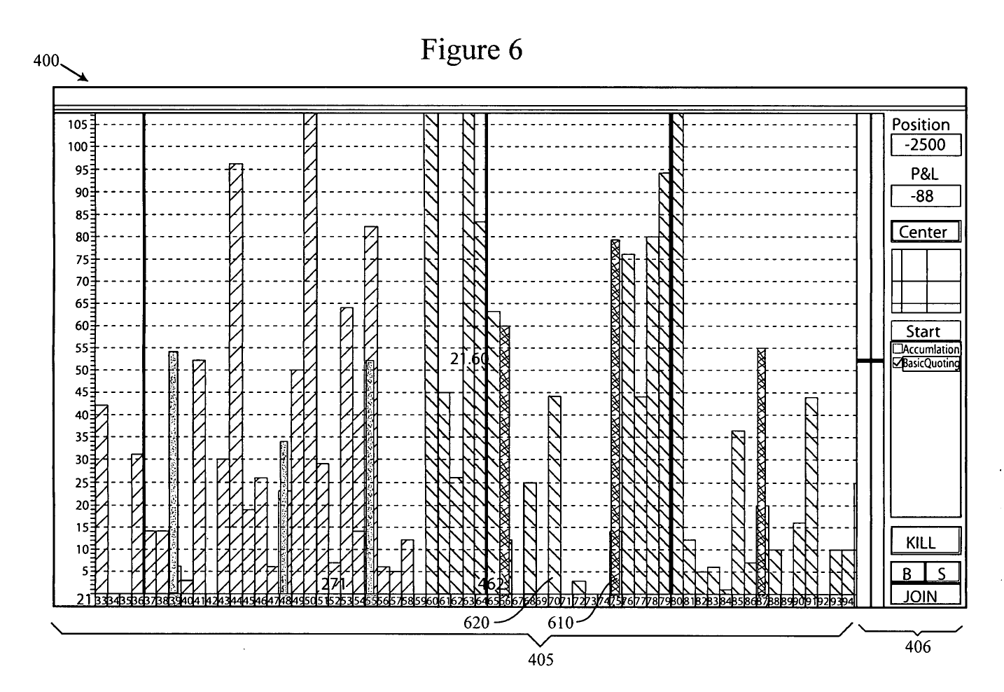

The present invention is applicable to the viewing and placing of trades on the equity market, the options market, or both markets at once. The GUI 400, as shown in FIG. 6, illustrates activity in the options market displayed coincidentally with activity in the equity market for the same security. For example, order 610 represents an existing options order. Option orders 610 can be differentiated from equity orders (e.g., order 620) by shading, color, or width of the histogram bar. For example, as illustrated in FIGS. 4 and 6, market activity 411 and 421 can be displayed using a wide bar having color X, options activity 610 can be displayed using a medium width bar having color Y, and equity user trade orders 435 can be displayed as the narrow bar having color Z.

The options market display can be set in various modes of operation. The options market can be turned off so that it is not displayed, and so that trade orders are executed without including the purchase or sale of options. Alternatively, the trading system 200 can be configured to display the options market, thus allowing the user to see what options exist, but not purchase any options. Additionally, the system can display the options market and allow users to purchase and sell options to fulfill their trading strategies. Moreover, if desired, the trading system 200 can fulfill all trade orders by first purchasing as many options as possible, or necessary, that satisfy the requirements of a trade order and then filling any deficiency in the trade order from the equity market. These modes are preferably selectable from the client terminal 110, for example, through controls presented in the user interface.

Preferably the server 120 distributes trade orders to the electronic exchange servers 140. In circumstances in which it is advantageous to divide and distribute a trade order across multiple electronic exchanges 140, the server 120 can evaluate predetermined parameters and split the trade order into multiple smaller trade orders for placement on the multiple electronic exchanges. The parameters used in this decision can include the volume/quantity of the trade order, the financial instrument specified by the trade order, the average trading volume of the financial instrument, the price of the trade order, the market price of the instrument, and other parameters that would be known to a person skilled in the art.

When a single trade order is divided into multiple sub-trades, the server can report fulfillment of each sub-trade to the client terminal 110. In this manner, the client terminal 110 displays an accurate representation of the user's position in the market even though the entire order may not have been fulfilled.

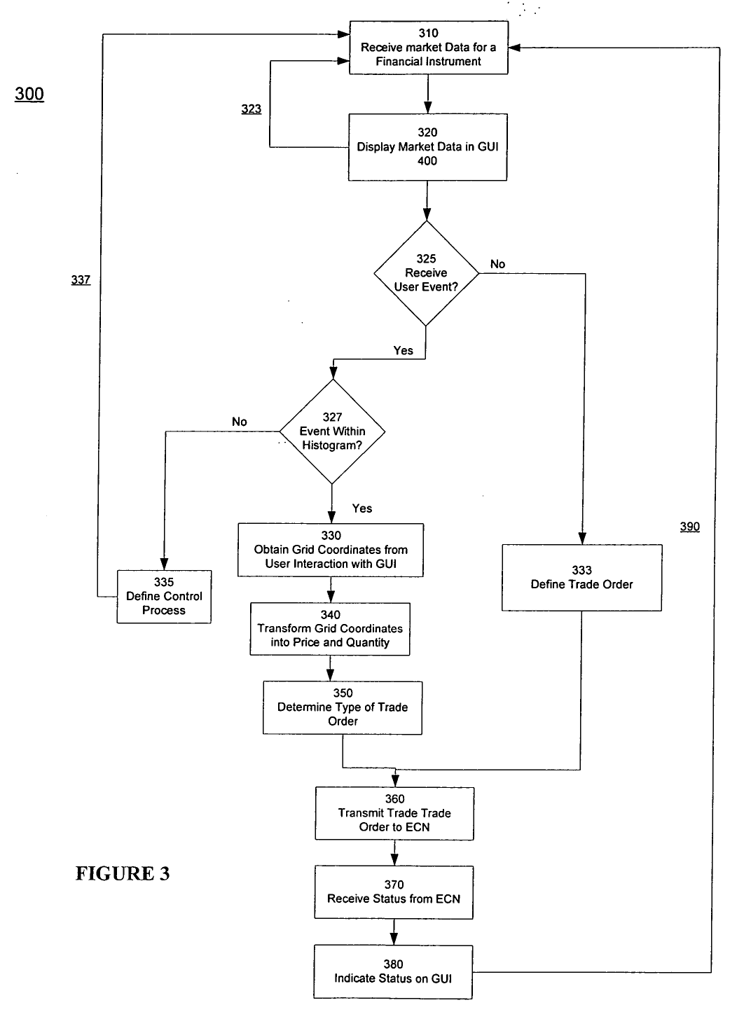

The modules described above cooperate in the overall operation of client terminal 110 by which a user can place a trade order. The process 300 by which a user can place a trade order is illustrated in FIG. 3, and describe below with reference to the steps illustrated in FIG. 3 and the modules described above.

The client terminal 110 receives market data for at least one financial instrument at step 310. Market data can be transmitted over a variety of network configurations, including TCP/IP networks and GPRS, 3G, or other wireless networks. For a specified financial instrument, market data includes the outstanding bids and offers and the current market price of a commodity. Market data may also include further information including option orders and volume. As previously discussed, market data can be transmitted using a standard protocol (e.g., FIX), or using a propriety protocol which marshals and demarshals data transmitted over the network. Because a commodity can be traded on multiple exchanges, market data may be received from more than one electronic exchange, which can be aggregated at the client terminal 110 or the server to determine the total market activity of a commodity. Transmissions received at the server communication module 240 can include any portion of the foregoing market data in any given communication.

The client 110 displays the market data in the GUI 400 at step 320. This data display includes a coordinate representation of price verses quantity, preferably in the form of a histogram 405. The histogram 405 is controlled and modeled, in part, by the orderbook module 210. The process of receiving market data 310 and displaying market data in the GUI 400, step 320, can be repeated (see arrow 323) either by periodically requesting an update from the electronic exchanges (i.e. pulling the data) or by receiving data pushed from the electronic exchanges 140. The steps of receiving market data 310 and displaying market data in the GUI 320 can be performed by a separate thread or process, thereby allowing the system to account for and display current or real-time market data as the processes in the trading system 200 are being performed (e.g., placing a user trade order).

In an event-based environment, the orderbook module 210 can register to receive market data published by a server, such as an ECN 140. Alternatively, the orderbook module 210 can register for customized market data that is collected, organized, managed, and/or processed by a server on a LAN, such as the server 120, which can be local to the larger infrastructure with which the client terminal 110 communicates. By registering with a server, market updates are automatically published (i.e., pushed) to the registered client terminal 110.

At step 325, the trading system 200 differentiates between events that are generated by a user interacting with the user pointer device 250 and internal events being generated for example by the market monitor module as part of a trading algorithm. If the event is internally generated (i.e., not a user event) process 300 proceeds to step 333 where a trade order is created having the parameters defined by the algorithm. The process 300 then transmits the trade order to an ECN at step 360.

When the event manager 257 detects an event generated by the user pointer device 255, the system determines the event is a user even at step 325, and proceeds to step 327 where the even manager 257 determines if the event is within the histogram window. If the event is within the histogram window, the process 300 proceeds to step 330 to obtain the grid coordinates from the user interaction with the GUI. The grid coordinates are transformed into a representative price and quantity of the specified financial instrument at step 340 by the order entry module 230.

The type of trade order is determined at step 350 by the order entry module 230. This determination can be made by determining whether the buy mode button 242 or the sell mode button 243 was selected, or by comparing the trade order price to the current market price of the specific financial instrument 490 and determining if the price of the trade order is greater than or less than the most recent market order 290 and deducing whether the order is on the buy side (less than market price) or the sell side (greater than market price), as described above.

The server communication module 240 of trading system 200 transmits the trade order generated by the order entry module 230 to at least one ECN 140 at step 360. If the system is configured to operate in an optimistic mode (i.e., assume orders are accepted by the ECN 140), the system automatically displays the newly placed order on the GUI 400. In the optimistic mode, if the electronic exchange rejects the trade order, the trade order is either removed from the GUI 400 or is displayed so as to indicate that the trade order was rejected. When the system is configured to operate in a pessimistic mode (i.e., assume trade orders are rejected by the ECN 140), the trading system 200 waits for receipt of a status indication from the ECN 140 at step 370, and indicates the status of the trade order on the GUI 400 at step 380 after receiving the status indicated from the electronic exchange. Either the optimistic or pessimistic modes can be the only mode of operation, and need not be a selectable configuration setting. Once the status is updated, the process loops back for real time market data display and user-event monitoring, via arrow 390.

If, at step 327, the event manager 257 determines that the user pointer device 250 event is not within the histogram, the event is transmitted to the appropriate software module at step 335 to define the control process to handle the event. For example, if the user interacts with the scaling module 235, the event manager 257 will transmit the event to the scaling module 235 which defines the control processes associated with increasing or decreasing the user's unfulfilled trade orders. Once the appropriate control process is defined at step 335, process 300 follows path 337 to continue receiving market data at step 310.

Various visual prompts can be displayed within the GUI 400 to convey the status of a trade order. Alert windows can be used to indicate a trade order has been rejected. Such alert windows can “pop-up” or be superimposed over the GUI 400, and can prevent the user from further interaction with the GUI until the alert window is acknowledge, for example by clicking “OK” or “Cancel.” Alternatively, pending orders can be shadowed, shaded/striped, blinking, or differentiated in some other manner. A different distinguishing manner of display can be used to indicate that an order has been accepted.

Multiple trade orders can be created and displayed in process 300. Although the process of FIG. 3 shows a linear progression of steps, a physical implementation need not be so constrained. Rather, market data can be received and displayed as a parallel process to any user interaction. Also, any user events that provide grid coordinates to be transformed into an order at steps 330 through 350 can be accepted through the GUI in rapid succession before steps 332 through 380 are performed or completed. The user does not need to wait for confirmation of each order created by a single user interaction. Similarly, the user does not need to change any parameters prior to entering additional orders. Rather, the user can quickly define multiple buy and sell orders simultaneously establishing prices and quantities in each sequential order by selecting arbitrary coordinates within the histogram 405.

The process described above, and illustrated in FIG. 3, is implemented by the trading system 200. More advanced and detailed functionality can be achieved and complement process 300 through additional software modules or modifications to software modules discussed above.

Multiple distinct orders can be tracked by the client terminal 110, or another computer in communication with the client terminal, through the inclusion of an order status module 260 and a data store 270. Referring again to FIG. 2, the order status module 260 communicates with the order entry module 230 to receive new orders, for example as a new trade order object. Trade order objects created by the order entry module 230 can be maintained within the data store 270 in various data structures such as a set, list, array, hash table, or tree structure. Each trade order object can contain a status data member indicating whether the order has been fulfilled, is pending, or cancelled. Alternatively, trade object orders can be stored in multiple data structures distinguishing fulfilled, pending, and cancelled orders.

The order status module 260 further updates the status of trade orders by reviewing trade order objects in the preferred embodiment on the GUI 400 through the graphical application interface 220. The trading system 200 can further utilize the order management capabilities of the ECN(s) 140 to which the client is connected, and does not require its own local storage (270) of pending orders. When a FIX trade order message arrives at the server communication module 240, the trade order data is parsed from the FIX message, and if determined to be a change in status of a trade order, the server communication module 240 can invoke a method provided by the order status module 260 and provide the necessary parameters to enable the order status module to update the status of the specified trade order. The order status module 260 can further update the data store 270 (if included) and the various modules of the client terminal 110 as necessary, including updating the GUI 400, the market monitor module 280 and algorithm library module 265. Thus, the trading system 200 enables a user to create, place, and track multiple trade orders at varying price points and of varying quantities for a particular commodity, and display each order on the histogram 405.

The trading system of the preferred embodiment enables trade order cancellation through the interface in various ways. A listing of pending orders can be displayed (not shown) and any order in the list can be selected and cancelled in a conventional manner. Alternatively, the interface enables order cancellation through the GUI 400 by positioning the user pointer device 250 at a location corresponding to an open order at a particular price and at a quantity location within the histogram (below or on x axis) that is zero or negative or null to entirely cancel the unfilled trade order. The instruction communicated at step 360 in response to this type of user even that cancels the unfilled trade order can be a standard means of communicating a predetermined message, such as a zero quantity, a negative quantity, or a null value.

Similarly, in accordance with another aspect of the present invention, users can modify the quantity of an existing order through a user interaction with the GUI 400 and the user pointer device 250. Specifically, the quantity of an existing, unfilled trade order can be modified by a user interaction with the interface at the location which corresponds to the unfilled trade order's price and a quantity different from the quantity of the unfilled trade order's quantity. When the new trade order quantity is smaller than the original, the order entry module can communicate with the server communication module 240 to generate a FIX message to cancel a portion of the existing order. Alternatively, the existing order can be cancelled by calling the cancel method of a trade object after locating the object within the order status module 260 creating a new trade order object specifying the desired quantity, and generating a new FIX message to place the new trade order. When the new trade order quantity is larger than the original trade order quantity, the order entry module 230 can both cancel the existing trade order and create a new trade order, or alternatively the order entry module 230 can create a new trade order object representing the additional quantity desired. Thus, through this subsequent user action, a user can either increase or decrease the quantity of a trade order. Optionally, modifications to existing unfilled orders can require a click and drag movement by the user using the pointing device 250 along the display of that order with a button release at the location of the new quantity that is desired.

The control potion 406 of the GUI 400 displayed by the client terminal 110 can include a magnification pad module 223 in communication with the graphical application interface 220. The magnification pad module 223 can display a portion of the histogram 405 in a magnified context (not shown) controlled by the order book module 210 in cooperation with the user pointer device 250. The user can select the magnification mode from a control displayed on the GUI 400 so that as the user pointer 250 moves through an arbitrary portion of the histogram 405, an area surrounding the user pointer can be magnified to increase the resolution of the histogram 405 and allow a user to more accurately place trades.

The control portion 406 of the GUI 400 can further display various statistics regarding the market, the specified financial instrument, or the user's position and performance with respect to the market or a specific instrument. A financial instrument can include equity shares of stock, bonds, options, ETFs, or a synthetic basket of stocks. By way of example, the control portion 406 in FIG. 4 includes a statistic component 408 which displays the user's position in the instrument displayed in the histogram 405 and the user's profit and loss with respect to that instrument. The statistical component 408 of the control portion 406 can include any informational display used by those in the art, including performance graphs, momentum indicators, and return on investment. Furthermore, the statistics can be displayed with reference to any of a number of market indices.

In some circumstances it may be desirable to create specific safeguards against mistake, abuse, or misuse of the trading system. For example the system could be put into a “training mode” in which each placed, changed, or cancelled order requires confirmation by the user. The confirmation can take the form of a pop-up window or other displayed message controlled by the order entry module 230 requiring the user to confirm all the parameters of the trade which are presented to the user for approval. Additionally, the order entry module 230 can reject or require confirmation of any order for a quantity of a commodity that is greater than predetermined threshold or any order for a commodity in which the total price of the trade order is greater than predetermined threshold.

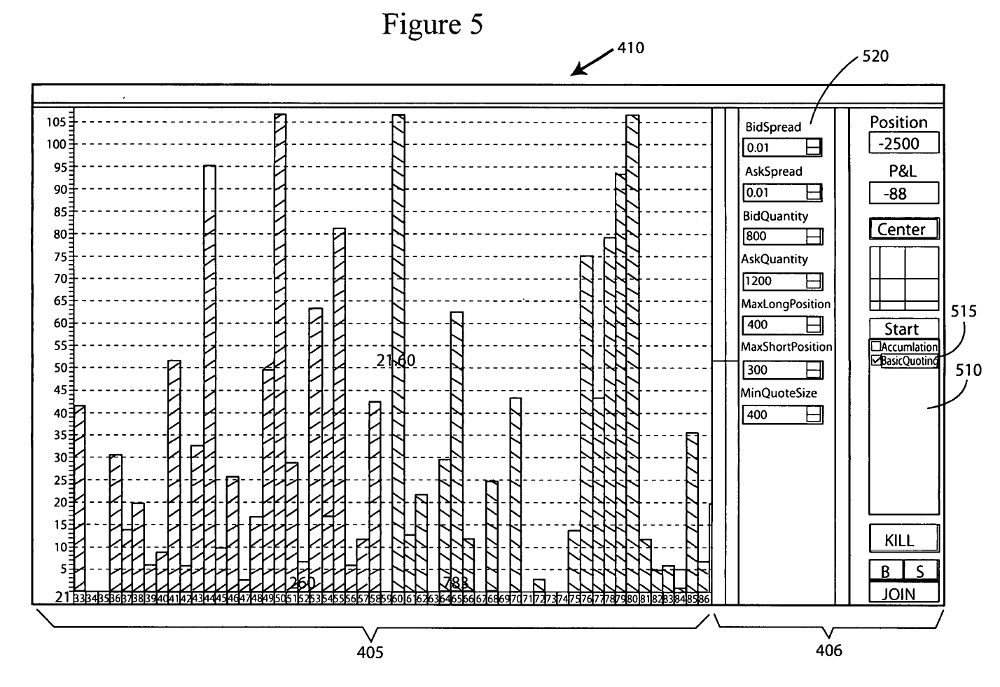

FIG. 5 depicts a further exemplary GUI 400 displaying trade-algorithm selection box 510 and algorithm inputs 520 within the control portion 406. Trading algorithms can be stored, executed, and controlled from the client terminal 110. In this regard, the software executing on the client terminal 110 preferably includes a market monitor module 280 that is in communication with order book module 210 to implement a user selected trading algorithm. Users select algorithm from the selection box 510 by interacting with the control portion 406 of the GUI 400 outside of the histogram region. In one example of trading algorithm, the market monitor module 280 tracks changes in the price of a financial instrument, and, based on at least one predetermined rule related to one or more of the tracked market indicators and rule parameters, executes a predefined action or triggers an action, typically by communicating with the order entry module 230. Rule parameters can include price, volume, market conditions or data, and user position and data. Trigger actions can be any action the system is capable of performing including modifying algorithm rule parameters, placing orders, canceling orders, killing the algorithm itself, and even killing an entirely different algorithm. The algorithm operates to create, modify and cancel orders in a conventional way, yet cooperates with the order entry module 230 and order status module 260 to confirm and update the order status on the display (step 380).

Referring now to FIGS. 2 and 5, algorithms can be managed by the algorithm library module 265, from which one or more algorithm can be selected and configured by the user. The algorithm library module 265 communicates with the graphical application interface 220 to direct the control portion 406 of the GUI 400 to display available algorithms from the algorithm library 510. An active algorithm 515 can be displayed with a checked checkbox or displayed in some other manner to indicate its active state. A user can select a specific algorithm, such as active algorithm 515, using the user pointer device 250 and in response, the control portion 406 can display a selection or parameters 520 associated with the selected algorithm. The user can interact with these displayed rule parameters 520 to vary the behavior and characteristics of the selected algorithm 515.

The market monitor module 280 can be provided to track individual financial instruments, a complex financial instrument comprising stocks, options, or derivative products, market indices, benchmarks, synthetic baskets or a combination of the foregoing. Synthetic baskets can be defined by the user by selecting financial instruments to include through the GUI interface, and can be traded in the same manner as any other financial instrument except that buy and sell orders concerning a basket will generate trade orders for each of the basket components in the same proportion that the components exist in the basket itself. Baskets can further be defined and published to the client by the server 120 to which the client is connected. Similarly, benchmarks can include an ETF, a single financial instrument, a market index, or an arbitrary basket of financial instruments. As FIX messages are received by the server communication module 240 and transmitted to the order book module 210, all or a selected portion of the market data can be forwarded to the market monitor module 280. The market monitor module 280 can populate its data structures with the market data or track references or pointers to market data objects generated by the server communication module 240 or the order book module 210. The type of data structure used by the market monitor module 280 to store the market data can depend on the analysis being performed to optimize for various operations include range searches, matching operations, random access, or statistical operations.

In a more particular feature, the market monitor module 280 detects and recognizes operating status changes of the ECN, and is capable of responding to those changes in a predefined manner. For example, the trading system 200 can appropriately respond when a financial instrument entering a slow market (i.e., when the commodity is no longer tradable on an electronic exchange). For instance, when the stock exchange enters a slow market, all electronic orders on the exchange are cancelled by the exchange. Thus, the market monitor module 280 can detect the switch to a slow market and instruct the order entry module to delete all pending orders on that exchange. Trade orders for the specified financial instrument on a different exchange that has not entered a slow market will still be viewable and tradable on the trading system 200.

In a multithreaded or multi-process environment, the cancel operation can be asynchronous thus enabling multiple trade order cancellation messages to be transmitted concurrently without requiring the trading system 200 to wait for and receive acknowledgment of the previously sent cancellation messages. Cancellation acknowledgements messages can be received by the server communication module 240 and processed accordingly.

As the user watches the market activity displayed in the histogram 405 in the GUI 400, the user may want to make general or systematic changes to his pending trade orders. One particular systematic change can be implemented programmatically by selecting the kill-button 450 displayed within the GUI 400. If the user selects the kill-button 450 with the user pointer device 250, the graphical application interface 220, which is in communication with the order entry module 230 and the order status module 260, cancels a target set of trade orders. The target set of trade orders can include a single financial instrument, all trade orders in a predetermined market sector, trade orders associate with predetermined algorithm, or all the unfilled trade orders that have been placed by the user.

The user also can make systematic changes to unfilled, pending orders by invoking the scaling module 235. The scaling module communicates with the order entry module 230 and the graphical application interface 220. The scaling module 235 directs the graphical application interface 220 to display within the GUI 400 one or more scaling sliders 452 and 454. In one preferred embodiment, the GUI includes a buy-scaling slider 452 and a sell-scaling slider 454. Scaling sliders 452 and 454 include scaler-bars 453 and 455. By manipulating the user pointer device 250 to interact with buy-scaler-bar 453, the user can increase or decrease all outstanding (that is, open and unfilled) buy trade orders for the financial instrument displayed within the histogram 405. Similarly, by interacting with sell-scaler-bar 455, the user can increase or decrease all outstanding sell trade orders for the financial instrument displayed within the histogram 405.

In operation, the user is presented with a GUI 400 on a computer display, preferably a tablet computer. The GUI 400 provides the user with an easily understandable graphical representation of the outstanding bids 421, offers 411, and options 610 for a specified financial instrument displayed on the histogram 405 in which the x-axis 450 represents the price and the y-axis 451 represents the quantity of market or user orders.

FIG. 4 represents a snapshot of the market for the financial instrument HPQ at a particular point in time. The GUI 400 displays the histogram 405 of the outstanding market orders. The user can instantly determine that the market price 490 of HPQ is $21.70. The sweep zone is between lower bound 470 at $21.60 and upper bound 475 at $21.75. The momentum is between lower bound 485 at $21.50 and upper bound 480 $21.80. The user can also instantly see that there is an outstanding user-buy-order 421 for 2500 shares at $21.54 and an outstanding offer orders for 3000 shares at $21.82 and 2550 shares at $21.88. The user's position of −3100 shares and a loss of $465 is also displayed in statistics component 408.

At a later point in time, the user may decide to cancel all outstanding order by pressing the kill button 450. The market data is displayed in the histogram after all the orders have been killed in FIG. 5. The user can decide to execute a trading algorithm and display the algorithm selection box 510. The user can then select an algorithm, for example the Basic Quoting algorithm, which will be displayed as an active algorithm 515. When selected by the user, the algorithm-parameter inputs 520 are displayed and controllable by the user.

FIG. 5 further displays that the market has shifted. The market price of HPQ in FIG. 5 is $21.60. The sweep zone has also shifted such that it is now between $21.60 and $21.75. Similarly, the momentum has shifted to the range between $21.50 and $21.80. After selecting a trading algorithm, the user can decide to view and trade the options-market as displayed in FIG. 6.

As the histogram 405 is being updated as described above, the user can place multiple orders in rapid succession by selecting the arbitrary position on the histogram corresponding to the price and quantity of the desired trade. For a given financial instrument, the user does not need to perform timely and tedious data entry to place a trade, rather a single user initiated interaction between the GUI 400 and the pointer device 250 simultaneously defines a price and quantity so as to create and place a trade. Similarly, the user can switch between commodities and user accounts through the GUI 400 and rapidly place orders by “tapping” or “clicking” in the corresponding arbitrary position on the histogram.

While the invention has been described in connection with a certain embodiment thereof, the invention is not limited to the described embodiments but rather is more broadly defined by the recitations in the claims below and equivalents thereof.

I claim:

1. A computer based trading system for trading one or more financial instruments on at least one of a plurality of electronic exchanges comprising:
a server and a first client terminal interconnected on a communication network;
the first client including a display, a GUI presentation on the display, and a graphical application interface module in data communication with the GUI;
an order book module in communication with the graphical application interface module, the order book module being configured to display on the GUI a histogram of market activity for a financial instrument occurring on at least one of the plurality of electronic exchanges;
an order entry module in communication with the graphical application interface module, the order entry module operable to analyze user actions and selectively create trade orders;
a user pointer device interactively coupled with the GUI so as to simultaneously provide a first value representing a price and a second value representing a quantity to the order entry module as coordinate pair data corresponding to an arbitrary location of interaction with the GUI based on a user action, wherein the coordinate pair data is available at continuous locations on the GUI;
a server communication module in communication with the order entry module configured to receive any trade order that has been created, and operable to transmit such trade orders to the server, wherein the server contacts at least one of the plurality of electronic exchanges so as to place the trade order.

2. The trading system of claim 1, further comprising at least one processor operable to execute instructions associated with the order entry module so as to transform the coordinate pair information into a trade order concerning the displayed financial instrument.

3. The trading system of claim 2, wherein the trade order is one of an order to buy the quantity of the financial instrument and an order to sell the quantity of the financial instrument; and
wherein the order entry module is operable to determine whether the trade order is a buy or sell order in response to the position of the arbitrary location relative to a market spread for the financial instrument provided by the order book module, and is further operable to establish the trade order as a buy or sell order in response to said determination.

4. The trading system of claim 1, wherein the order entry module is operable to analyze user actions occurring coincident with the market activity histogram.

5. The trading system of claim 1, wherein the order entry module is further operable to superimpose a visual indication of a created trade order on the market activity histogram.

6. The trading system of claim 5, wherein the created trade order is displayed after a status indication is received from the at least one electronic exchange.

7. The trading system of claim 6, wherein the status indication acknowledges acceptance or rejection of the created trade order; and
wherein the visual indication of the created trade order provides a visual indication of the status.

8. The trading system of claim 1, further comprising:
a data store, configured to store a plurality of trade orders, and
an order status module in communication with the order entry module so as to maintain the data store.

9. The trading system of claim 8, wherein the order status module is further configured to cancel unfilled trade orders when a user action provides a first value representing an unfilled defined trade order price and a second value representing an instruction to cancel the unfilled defined trade order.

10. The trading system of claim 1, wherein the order entry module is further configured to selectively create second and more trade orders in response to subsequent arbitrary locations of interaction between the user pointer device and the GUI based on user actions.

11. The trading system of claim 1, wherein the order entry module is further configured to modify the quantity of an unfilled trade order when a subsequent interaction between the user pointer device and the GUI provides a first value representing the unfilled trade order price and a second value representing a quantity greater than zero, wherein the unfilled trade order quantity is changed to the amount of the second value.

12. The trading system of claim 1, further comprising a magnification pad module in communication with the graphical application interface module, the magnification pad module being operable to display a magnified portion of the order book component in cooperation with operation of the user pointer device.

13. The trading system of claim 2, wherein the at least one processor is further operable to execute instructions so as to divide the trade order into a plurality of sub-trade orders to be placed on respective electronic exchanges among the plurality of electronic exchanges.

14. The trading system of claim 1, wherein the market activity includes bid orders and sell orders, and wherein the order book module is further operable to have bid orders displayed in a first manner and sell orders displayed in a second differentiating manner.

15. The trading system of claim 14, wherein a created trade order is one of an order to buy the quantity of the financial instrument and an order to sell the quantity of the financial instrument; and
wherein the order book module is further operable to have buy orders displayed in a third differentiating manner and sell orders displayed in a fourth differentiating manner.

16. The trading system of claim 1, wherein the GUI order book module is further operable to control the display of visual indications of a sweep zone for the financial instrument.

17. The trading system of claim 1, wherein the GUI order book module is further operable to control the display of a visual indication of a momentum range for the financial instrument.

18. The trading system of claim 1, further comprising a user controllable object in the GUI that implements selection of a financial instrument market activity, so as to switch from displaying a first financial instrument market activity to at least a second financial instrument market activity.

19. The trading system of claim 1, further comprising a statistics module in communication with the graphical application interface, the statistics module operable being configured to display on the GUI statistical information relating to the market activity of at least one financial instrument.

20. The trading system of claim 19, wherein the statistics module is further operable to display at least the user's position in the at least one financial instrument and the user's profit or loss with respect to the at least one financial instrument.

21. The trading system of claim 1, wherein the order entry module is further operable to reject placement of a trade order if the quantity of the trade order exceeds a predetermined threshold.

22. The trading system of claim 1, further comprising a market monitor module in communication with the order book module, the market monitor being operable to implement an algorithm that tracks changes in a financial instrument price, and is further operable to execute a predefined action based on at least one predetermined rule.

23. The trading system of claim 22, wherein the market monitor module is further operable to detect when the financial instrument enters a slow market and cancel all outstanding orders.

24. The trading system of claim 22, further comprising:
an algorithm library module that contains a selection of algorithms, wherein each algorithm has at least one user selectable parameter; and
the algorithm library module is operable to implement a user-selected algorithm.

25. The trading system of claim 22, wherein the market monitor module is further operable to implement a plurality of algorithms, wherein each algorithm includes a plurality of parameters, a selection of reference benchmarks, and a trigger action that causes a response performance;
wherein a performance of the reference benchmark is tracked by the market monitor module, and the trigger action is defined in relation to the reference benchmark performance.

26. The trading system of claim 25, wherein the reference benchmark is at least one of an ETF, a single financial instrument, a market index, and a financial instrument basket.

27. The trading system of claim 25, wherein the reference benchmark is a synthetic financial instrument basket created by the user.

28. The trading system of claim 25, wherein the response performance includes at least one of modifying the algorithm parameters, placing one or more trade orders, killing the algorithm, and killing a different algorithm.

29. The trading system of claim 1, further comprising a scaling module operable to scale at least one of a price and a quantity of a trade order by a selectable percentage.

30. The trading system of claim 8, further comprising a kill button object in the GUI that is activated by a user interaction with the user pointer device; and
wherein the order status module is further configured, in response to activation of the kill button, to cancel a predetermined target set of trade orders among the plurality of trade orders.

31. The trading system of claim 30, wherein the predetermined target set of trade orders is at least one of trade orders for a single financial instrument, trade orders for a predetermined market sector, trade orders associated with a predetermined algorithm, and trade orders placed by the user.
